(19) United States
(12) Patent Application Publication
(10) Pub. No.: US 2025/0254032 A1
(43) Pub. Date: Aug. 7, 2025

(54) SYSTEM AND METHODS FOR PERSISTENTLY IMPLEMENTING POST-QUANTUM SECURITY VIA SERVICE WORKERS

(71) Applicant: QuSecure, Inc., Petaluma, CA (US)

(72) Inventors: CHRISTOPHER L. TRINIDAD, Hayward, CA (US); CHONGRUI DUAN, San Carlo, CA (US); Scott Kawaguchi, San Jose, CA (US)

(73) Assignee: QuSecure, Inc., Petaluma, CA (US)

(21) Appl. No.: 19/111,772

(22) PCT Filed: Dec. 29, 2022
(86) PCT No.: PCT/US2022/082576

§ 371 Date: Mar. 13, 2025

(51) Int. Cl. H04L 9/08

(52) U.S. Cl. CPC H04L 9/0852

(57) ABSTRACT

A method of custom cryptography is provided. The method can include receiving, by a loader site from a second computing device, a forwarded request of a third computing device. The forwarded request may not satisfy a security condition. The method can further include sending, by the loader site to the third computing device, a persistent service worker configured to initiate a proxy service. The proxy service may be configured to perform post-quantum custom cryptography. The post-quantum custom encryption and/or decryption can comprise Quantum Secure Layer (QSL), Post-Quantum Transport Layer Security (PQTLS), Kyber, SABER, Enhanced McEliece, RLCE, or a National Institute of Standards and Technology (NIST) candidate post-quantum algorithm, the persistent service worker may be configured to persist from a first browser session to a subsequent browser session of the third computing device. The persistent service worker can comprise a web worker or script instructions.

### CROSS-REFERENCE TO RELATED APPLICATIONS

This application claims the benefit of priority of U.S. Provisional Application No. 63/389,342, titled “Browser-Based Proxy and Custom Encryption” and filed on Jul. 14, 2022.

### BACKGROUND OF THE INVENTION

The development of non-classical computers, such as quantum computers, may pose a threat to existing encryption algorithms. There is a need for improved security systems that may be more resilient to non-classical computers.

### SUMMARY OF THE INVENTION

In an aspect the present disclosure provides a method of custom cryptography. The method of custom cryptography may comprise executing portable binary instructions within a secure virtualized environment of a user agent to perform post-quantum custom encryption and/or decryption of a user request and/or a request response.

In some embodiments, the post-quantum custom encryption and/or decryption can comprise a Quantum Secure Layer (QSL) protocol or a Post-Quantum Transport Layer Security (PQTLS) protocol.

In some embodiments, the post-quantum custom encryption and/or decryption can comprise at least one of: a Kyber algorithm; a SABER algorithm; an Enhanced McEliece algorithm; a Random Linear Code Encryption Scheme (RLCE) algorithm; or a National Institute of Standards and Technology (NIST) candidate post-quantum algorithm.

In some embodiments, the portable binary instructions can comprise a bytecode.

In some embodiments, the secure virtualized environment can comprise an independent context of execution within the user agent. The independent context of execution can have an independent memory space.

In some embodiments, the independent context of execution can comprise a virtual machine (VM) or a portable binary interpreter.

In some embodiments, the user agent can comprise a web browser or another client application.

In some embodiments, the portable binary instructions executed to perform the post-quantum custom encryption and/or decryption are encapsulated within a first custom cryptography binary instruction module.

In some embodiments, the method can further comprise exchanging the first custom cryptography binary instruction module with a second custom cryptography binary instruction module.

In another aspect, the present disclosure provides a computing system configured to perform custom cryptography. The computing system can comprise a memory and at least one processor coupled to the memory and configured to execute portable binary instructions within a secure virtualized environment of a user agent. The portable binary instructions can comprise portable binary instructions to perform post-quantum custom encryption and/or decryption of a user request and/or a request response.

In another aspect, the present disclosure provides a non-transitory computer readable medium storing executable sequences of instructions to perform custom cryptography, the executable sequences of instructions comprising instructions to execute portable binary instructions within a secure virtualized environment of a user agent. The portable binary instructions can comprise portable binary instructions to perform post-quantum custom encryption and/or decryption of a user request and/or a request response.

In another aspect, the present disclosure provides a method of enabling custom cryptography. The method can comprise sending, by a first computing device and to a second computing device, instructions to initiate a proxy. The proxy can be configured to intercept a message of a user agent. The user agent may be associated with the second computing device. The proxy can be further configured to perform custom cryptography based on the message to obtain a modified message. The custom cryptography may comprise post-quantum cryptography. The proxy can be further configured to send the modified message to at least one of the user agent, a reverse proxy, or a third computing device.

In some embodiments, the post-quantum cryptography can comprise at least one of: a Quantum Secure Layer (QSL) protocol; a Post-Quantum Transport Layer Security (PQTLS) protocol; a Kyber algorithm; a SABER algorithm; an Enhanced McEliece algorithm; a Random Linear Code Encryption Scheme (RLCE) algorithm; or a National Institute of Standards and Technology (NIST) candidate post-quantum algorithm.

In some embodiments, while performing custom cryptography based on the message, the proxy is further configured to decrypt the message via the custom cryptography to obtain the modified message. While sending the modified message, the proxy can be further configured to send the modified message to the user agent.

In some embodiments, while performing custom cryptography based on the message, the proxy is further configured to encrypt the message via the custom cryptography to obtain the modified message. While sending the modified message, the proxy can be further configured to send the modified message to the reverse proxy or the third computing device.

In some embodiments, while performing custom cryptography based on the message, the proxy is further configured to encapsulate the message as a payload within an outer message. In some embodiments, while performing custom cryptography based on the message, the proxy is further configured to extract an inner payload from the message.

In some embodiments, while encapsulating the message as the payload within the outer message, the proxy is further configured to encapsulate an original header of the message within the payload and generate a modified header for the outer message.

In some embodiments, the message comprises a modified header. While extracting the inner payload from the message, the proxy may be further configured to extract an original header from the inner payload.

In some embodiments, the modified header comprises a modified destination path and the original header comprises an original destination path.

In some embodiments, the user agent is configured to perform a first encryption and/or decryption based on the message or the modified message. The custom cryptography can comprise a second encryption and/or decryption.

In some embodiments, while performing custom cryptography based on the message, the proxy is further configured to initiate portable binary instructions within a secure virtualized environment associated with the user agent.

In some embodiments, while sending the modified message, the proxy is further configured to send the modified message to the reverse proxy. The reverse proxy can be hosted by the third computing device.

In some embodiments, the third computing device comprises a Hypertext Transfer Protocol (HTTP) and/or Hypertext Transfer Protocol Secure (HTTPS) server. The message can comprise at least one of: a POST request to the HTTP and/or HTTPS server; a GET request to the HTTP and/or HTTPS server; another request; or a response from the HTTP and/or HTTPS server.

In some embodiments, the proxy is hosted by the second computing device.

In some embodiments, the user agent comprises a browser. The second computing device can comprise a client device. The browser can be executed by the client device.

In some embodiments, the first computing device comprises a custom cryptography server.

In some embodiments, the instructions to initiate the proxy comprise instructions to overload a library of the user agent with script instructions configured to implement the proxy. The instructions to initiate the proxy can further comprise instructions to execute, by the user agent, the script instructions.

In another aspect, the present disclosure provides a computing system configured to enable custom cryptography. The computing system can comprise a memory and at least one processor coupled to the memory and configured to send, to a second computing device, instructions to initiate a proxy. The proxy can be configured to intercept a message of a user agent. The user agent can be associated with the second computing device. The proxy can be further configured to perform custom cryptography based on the message to obtain a modified message. The custom cryptography can comprise post-quantum cryptography. The proxy can be further configured to send the modified message to at least one of the user agent, a reverse proxy, or a third computing device.

In another aspect, the present disclosure provides a non-transitory computer readable medium storing executable sequences of instructions to enable custom cryptography, the executable sequences of instructions comprising instructions to implement a proxy. The proxy can be configured to intercept a message of a user agent. The proxy can be further configured to perform custom cryptography based on the message to obtain a modified message. The custom cryptography can comprise post-quantum cryptography. The proxy can be further configured to send the modified message to at least one of the user agent, a second proxy, or a computing device.

In some embodiments, to perform custom cryptography based on the message further comprises to decrypt the message via the custom cryptography to obtain the modified message.

In some embodiments, to perform custom cryptography based on the message further comprises to encrypt the message via the custom cryptography to obtain the modified message.

In some embodiments, the instructions to implement the proxy comprise instructions to implement, by a client computing device, the proxy. The proxy can comprise a forward proxy.

In some embodiments, the user agent is associated with the client computing device. The instructions to implement, by the client computing device, the proxy can further comprise instructions to overload a library of the user agent.

In some embodiments, the instructions to overload the library of the user agent comprise script instructions executable via the user agent.

In some embodiments, the instructions to implement the proxy comprise instructions to implement, by a server, the proxy. The proxy can comprise a reverse proxy.

In another aspect, the present disclosure provides a method of custom cryptography. The method can comprise receiving, by a loader site from a second computing device, a forwarded request of a third computing device. The forwarded request may not satisfy a security condition. The method can further comprise sending, by the loader site to the third computing device, a persistent service worker configured to initiate a proxy service. The proxy service may be configured to perform post-quantum custom cryptography.

In some embodiments, the post-quantum custom cryptography can comprise at least one of: a Quantum Secure Layer (QSL) protocol; a Post-Quantum Transport Layer Security (PQTLS) protocol; a Kyber algorithm; a SABER algorithm; an Enhanced McEliece algorithm; a Random Linear Code Encryption Scheme (RLCE) algorithm; or a National Institute of Standards and Technology (NIST) candidate post-quantum algorithm.

In some embodiments, the persistent service worker is configured to persist from a first browser session to a subsequent browser session of the third computing device.

In some embodiments, the persistent service worker comprises a web worker. In some embodiments, the persistent service worker comprises script instructions.

In some embodiments, a request received by the second computing device is determined, by a policy manager, not to satisfy the security condition. The forwarded request can be forwarded, by the second computing device, based on the determination of the policy manager.

In some embodiments, the security condition indicates whether the forwarded request conforms to a post-quantum security standard or protocol.

In some embodiments, the security condition indicates whether the persistent service worker has been initiated. In some embodiments, the security condition indicates whether the proxy service has been initiated.

In some embodiments, the proxy service can be configured to intercept a message of a user agent. The proxy service can be further configured to initiate portable binary instructions within a virtualized environment of the user agent. The portable binary instructions can comprise instructions to modify the message via custom cryptography. The proxy service can be further configured to obtain the modified message. The proxy service can be further configured to send the modified message to a reverse proxy of the second computing device.

In some embodiments, the proxy service can be further configured to send the modified message to the user agent or the third computing device.

In some embodiments, to initiate the portable binary instructions can comprise to load and/or to initialize a cryptographic library module. The cryptographic library module can include the portable binary instructions.

In some embodiments, the persistent service worker can be further configured to determine whether a session associated with the persistent service worker remains active. Responsive to the session being inactive, the persistent service worker can be further configured to reestablish the session.

In another aspect, the present disclosure provides a loader computing system configured for custom cryptography. The loader computing system can comprise a memory; and at least one processor coupled to the memory and configured to receive, from a second computing device, a forwarded request of a third computing device. The forwarded request may not satisfy a security condition. The processor can be further configured to send, to the third computing device, a persistent service worker configured to initiate a proxy service. The proxy service can be configured to perform post-quantum custom cryptography.

In another aspect, the present disclosure provides a non-transitory computer readable medium storing executable sequences of instructions for custom cryptography. The executable sequences of instructions can comprise instructions to receive, from a second computing device, a forwarded request of a third computing device. The forwarded request may not satisfy a security condition. The executable sequences of instructions can further comprise instructions to send, to the third computing device, a persistent service worker configured to initiate a proxy service. The proxy service can be configured to perform post-quantum custom cryptography.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a block diagram illustrating a system for portably and transparently integrating post-quantum cryptography in communications, according to an embodiment of the present disclosure.

FIG. 2 is a block diagram illustrating a system for proxying and double encryption and/or double decryption, according to an embodiment of the present disclosure.

FIG. 3 is a block diagram illustrating a virtual machine implementing custom cryptography within a secure virtualized environment of a client application, according to an embodiment of the present disclosure.

FIG. 4 illustrates encapsulation and custom encryption and/or decryption, according to an embodiment of the present disclosure.

FIG. 5A is a communication flow diagram illustrating a method of proxying via a service worker to implement double encryption and/or double decryption, according to an embodiment of the present disclosure.

FIG. 5B is a communication flow diagram illustrating a method of proxying via a service worker to implement double encryption and/or double decryption, according to an embodiment of the present disclosure.

FIG. 6 is a flow diagram illustrating a method of proxying via a service worker, according to an embodiment of the present disclosure.

FIG. 7A is a flow diagram illustrating a method of custom encryption and/or decryption, according to an embodiment of the present disclosure.

FIG. 7B is a flow diagram illustrating details of a method of double encryption and/or double decryption, according to an embodiment of the present disclosure.

FIG. 8 is a block diagram of an example computer system which can perform any one or more of the methods described herein, in accordance with one or more aspects of the present disclosure.

### DETAILED DESCRIPTION

The invention will now be described more fully hereinafter with reference to the accompanying drawings, in which illustrative embodiments of the invention are shown. While various embodiments of the invention are shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” “less than or equal to,” or “at most” precedes the first numerical value in a series of two or more numerical values, the term “no more than,” “less than,” “less than or equal to,” or “at most” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, like characters refer to like elements.

Quantum computing technology currently under development may pose a threat to existing encryption algorithms, for example quantum computers may soon be able to break classical cryptographic algorithms. In particular, using a quantum computer, an attacker could potentially break into a private network and defeat classical cryptographic protections in order to compromise stored data, such as user data, sensitive data stored in secure computer systems, and the like. Accordingly, improved security systems have been developed, and continue to be developed, that are more resilient to non-classical computers such as quantum computers. For example, the National Institute of Standards and Technology (NIST) post-quantum encryption competition candidate algorithms are resilient against such quantum computing attacks. In order to improve adoption and portability of such post-quantum cryptographic methods, it is desirable to be able to execute custom cryptographic libraries, such as libraries implementing the NIST candidate post-quantum cryptographic methods, on demand from any client communication application, for example any web browser. The disclosed system and methods can address this need.

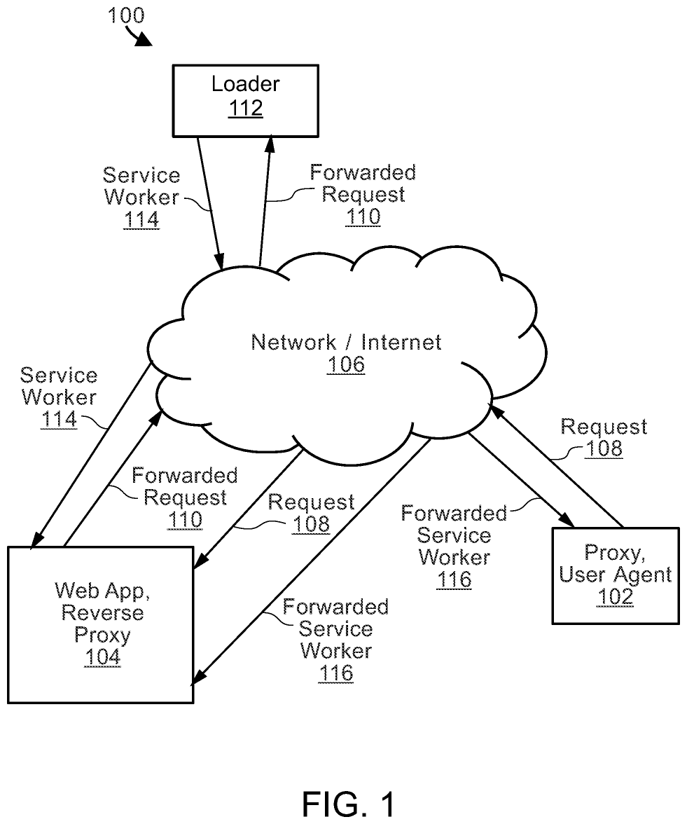

FIG. 1 is a block diagram illustrating a system 100 for portably and transparently integrating custom cryptography, such as post-quantum cryptography, in communications, according to an embodiment of the present disclosure. According to one aspect, the disclosed system provides a service worker (SW) 114 that can initiate a proxy service with a user agent 102 (for example, a client device executing a browser), ensure the proxy service remains active, and/or can itself implement the proxy service functionality. According to this aspect, the disclosed system also provides a loader site 112 that can send the service worker 114 to the client 102. The example of FIG. 1 illustrates how the loader site 112 and service worker 114 can ensure that the client 102 loads and uses the proxy service to provide post-quantum security, in a way that is transparent to a user of client 102. The proxy service may also be referred to as a proxy or a forward proxy.

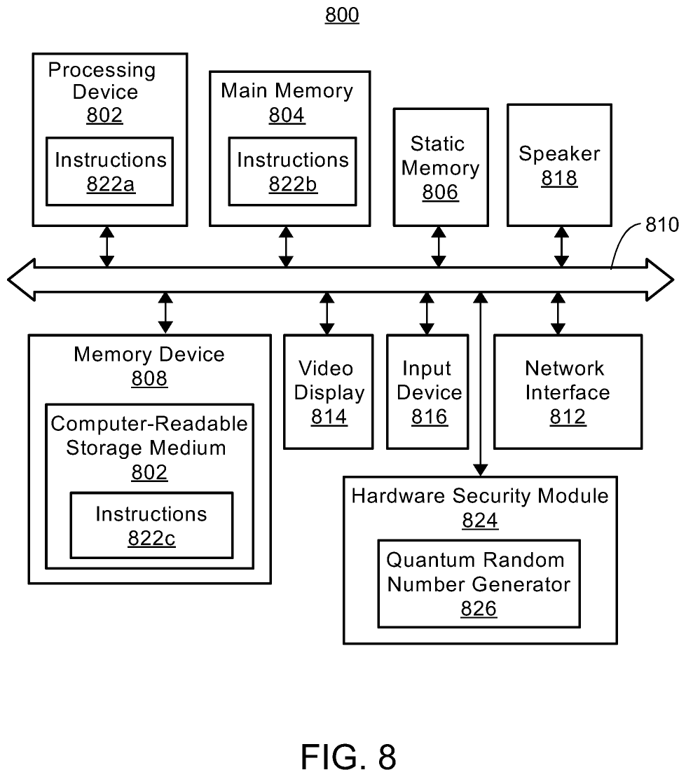

In this example, a client 102 can send a client request 108 to a web application and reverse proxy 104 (for example, a web server or other server with a reverse proxy), via a network 106, such as the Internet. In various embodiments, the client 102 may be a client computing system, such as the computer 800 of the example of FIG. 8 below, and/or any other client device, such as a mobile device. For example, a client application executed by the client 102, such as a browser, may send to the server 104 an HTTPS GET request for a website hosted by server 104, or otherwise associated with server 104. In various examples, the request 108 may include an HTTP or HTTPS POST request, a GET request, a PUT request, a DELETE request, and/or any other client request. The server 104 may include a server computing system, such as the computer 800 of FIG. 8, and/or any other server device or system. The server 104 may also make use of a reverse proxy to provide post-quantum security, as described herein below.

Upon receiving the client request 108, the server 104 (and/or a reverse proxy executed by the server 104) can then determine whether the request satisfies a security condition, such as the request 108 conforming to a post-quantum security standard or protocol, the service worker or proxy service having been initiated, or the request 108 being part of an established session. In some examples, when the request 108 conforms to a post-quantum security standard or protocol, this may imply that the service worker or proxy service has been initiated. Therefore, in some examples, the security condition may indicate whether the request 108 is secure and/or whether the request 108 conforms to a post-quantum security standard or protocol.

If the request 108 fails the security condition (for example, because the request conforms to a legacy or quantum-unaware protocol), the server 104 and/or the reverse proxy can forward 110 the request and/or send a notification to a loader site 112. For example, the loader site 112 may be an offsite server and/or a third-party service.

In response to the forwarded request 110, loader site 112 can send a service worker 114 to the server 104 and/or the reverse proxy. The server 104 and/or reverse proxy can, in turn, serve 116 the service worker to client 102 via the network 106, such as the Internet. The client 102 can load the service worker 116. A service worker (SW) is a feature of modern browsers, specifically a subset of Web Workers that can be created to cache assets (for example, HTML, JavaScript, CSS, and images) for offline use.

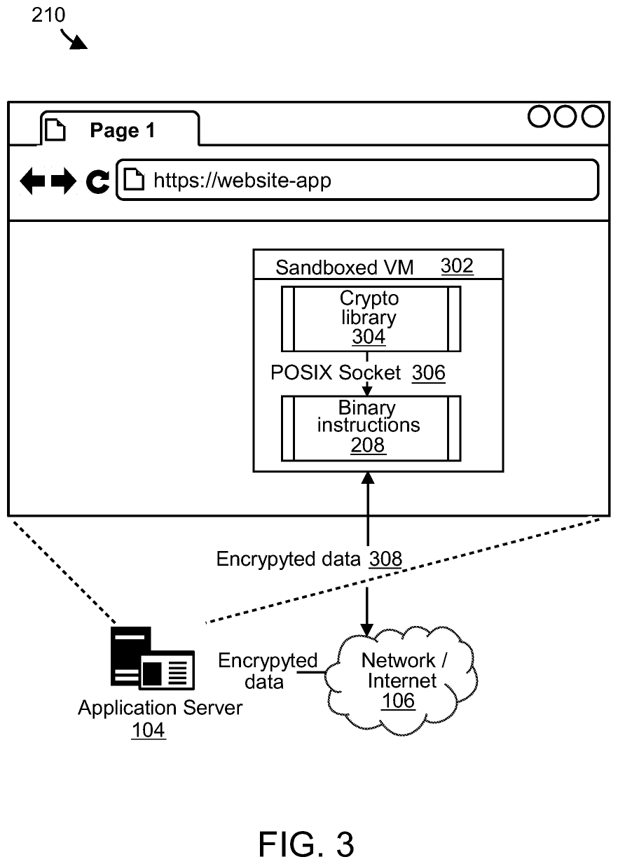

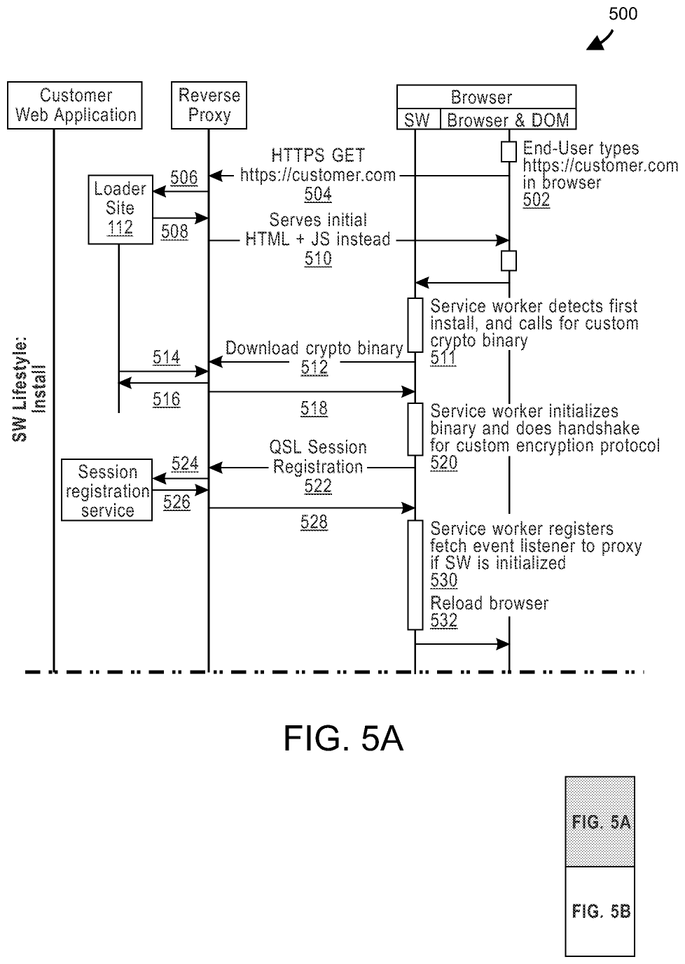

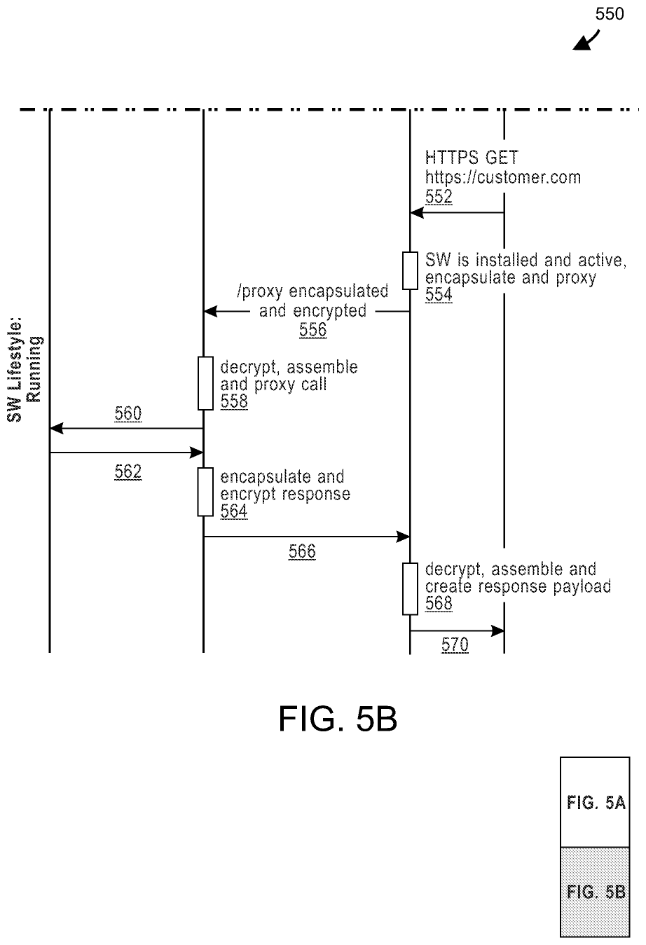

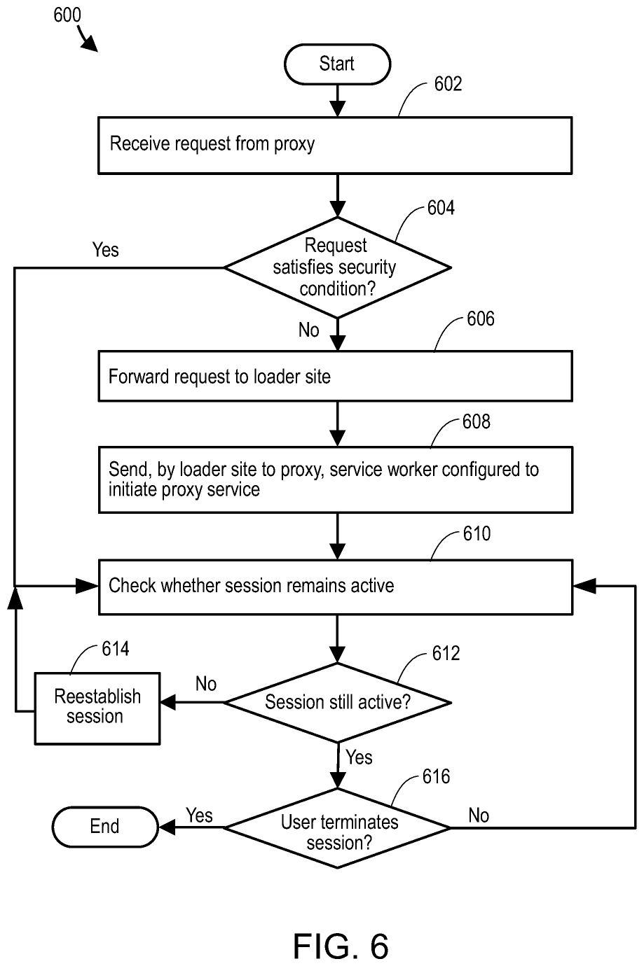

Once initialized, the service worker 116 may ensure that the proxy service is active in client 102, thereby ensuring that all communications between client 102 and server 104 are quantum-aware. In some examples, when checking whether an asset is cached during a network call, the SW's instructions may include additional logic to create a smart proxy for each network call. This proxy can handle the loading and initialization of crypto libraries. The proxy can also make use of interception handlers, which can parse through all request and response messages to perform double encryption and/or decryption. For example, a proxy instance running in a user agent (such as a web browser or other client application) can intercept all network requests, including all assets (HTML, JS, CSS, images) and HTTP calls, and can perform custom cryptography. Loading the proxy service will be described in greater detail in FIGS. 5-6 below, and custom encryption and/or decryption will be described in greater detail in FIGS. 3-5 and 7A-7B below.

In some examples, the proxy service can remain active as long as the service worker is active. Because service workers are designed to be persistent (e.g., a service worker can hibernate and/or revive even after the browser has been closed), the proxy can also persist from one session to another. Thus, in some embodiments, after the client application's first visit to the site hosted by the server 104, loader site 112 does not need to reload the service worker on subsequent visits. In some examples, the proxy service and/or the service worker may expire and/or be reloaded after a predetermined period of time, and are not limited by the present disclosure.

In some examples, the system may implement lifecycle methods to check whether the proxy service remains operational, for example by implementing listeners for the service worker and/or for revival of the service worker. The user agent (e.g., a browser) may manage when a SW persists in memory, hibernates, or is killed due to disuse or due to the passage of an expiration time. The user agent may detect when the SW is revived, and may perform checks depending on how the SW was revived or brought into communication with the user agent. For example, the user agent may reinitialize the SW, or determine that the SW's session with the proxy is still active, and continue the session.

The disclosed system and methods improve over other cryptographic systems by initiating instructions for the proxy beginning from the user agent's first access to the server. For example, the smart reverse proxy can serve an initialization page, which can include instructions for the SW and/or proxy service, to the user agent. Throughout the lifecycle of the SW, the proxy instructions can handle initializing, activating, and executing the double encryption and/or decryption. For example, during the execution step, instructions that detect whether the SW is activated may additionally provide a seamless transition that can reload the user agent (e.g., a browser or other client application). The SW may then actively proxy every request of the user agent to all other assets, beginning from the first request (e.g., an HTTP or HTTPS request for HTML). The instructions in the execution step can also monitor for subsequent requests, as the user agent interacts with the reverse proxy and/or server.

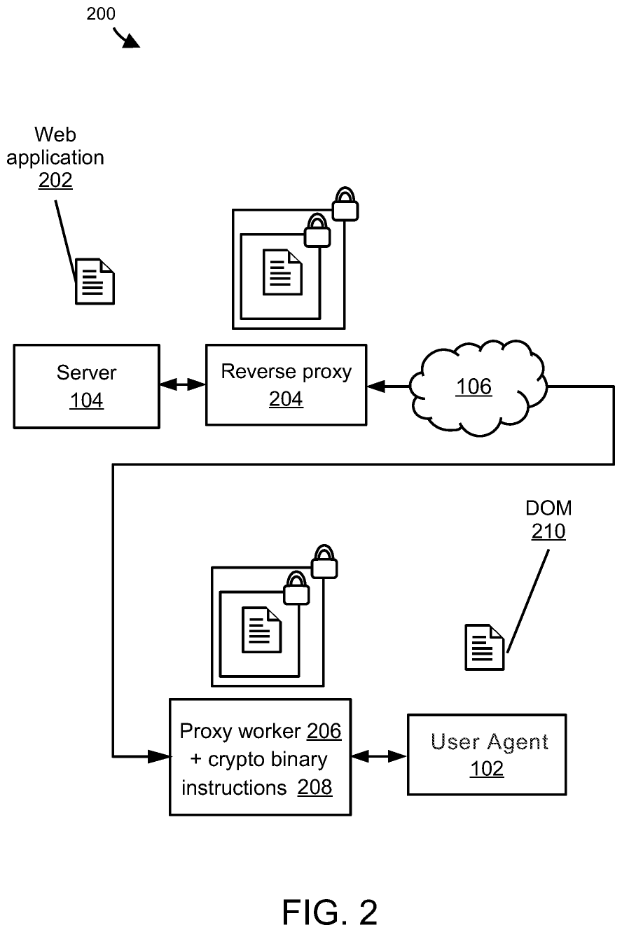

FIG. 2 is a block diagram illustrating a system 200 for proxying and double encryption and/or double decryption, according to an embodiment of the present disclosure. As disclosed herein, system 200 can provide a browser-based post-quantum cryptography solution, without requiring installation of a custom browser having compiled cryptography libraries or rewritten web applications. In particular, using the disclosed system and methods, the server 104, reverse proxy, and/or a loader site 112 can serve a service worker to the client 102 in response to a client request, as described in the examples of FIG. 1 above and FIG. 6 below. The service worker can then ensure that the client 102 and/or a user agent loads a proxy 206, for example implemented via a script such as JavaScript. The proxy 206, in turn, may call a cryptographic application, for example implemented via a portable binary.

The system 200 can make use of both a reverse proxy 204 on the side of server 104, and a forward proxy 206 on the side of client 102. Reverse proxy 204 may intercede between server 104 and network 106, such as the Internet, and forward proxy 206 may intercede between client 102 and network 106. For example, reverse proxy 204 and forward proxy 206 may intercept messages sent between server 104 and client 102, respectively, and the network 106.

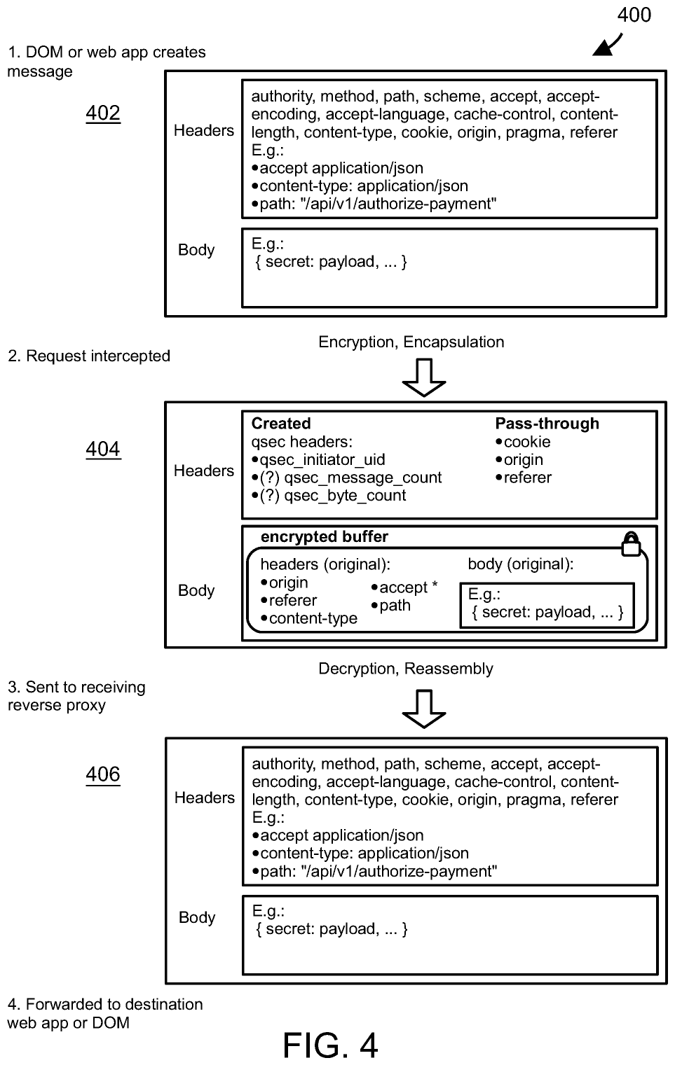

In some examples, the proxy's message-interception functionality may be implemented by modifying HTTP or HTTPS Application Programming Interfaces (APIs) or libraries (for example, APIs or libraries that perform fetch operations) so as to inject interception functions. These interception functions may contain instructions in a scripting language like JavaScript, and may be executed by a user agent such as a web browser. These interception handler functions may fundamentally mutate the original request or response before the browser or other user agent receives it. In particular, the interception functions may include instructions to encapsulate the body and headers of the request (as described in the example of FIG. 4 below), encrypt this encapsulated payload via an initialized cryptographic library and/or portable cryptographic binary instructions 208, and deliver the encrypted request to the reverse proxy 204 situated on the side of server 104. The response from this request may be returned in encapsulated and encrypted form as well, and accordingly the proxy and/or interception functions can perform the reverse steps of decryption and re-assembly of the original response object from the originator, as disclosed herein.

In this example, the client 102 may use a user agent or downloaded content 210, such as web content, a document object model (DOM), Hypertext Markup Language (HTML) or Cascading Style Sheets (CSS) content, a web page, and/or an app, to interact with server-side content 202 hosted by the server 104, such as a web or server-side application. For example, the client 102 and/or the user agent 210 may send a user request to the server 104 and/or the server-side content 202 via the network 106, such as the Internet. In another example, the server 104 and/or the server-side application 202 may send information, such as a response, to the client 102 and/or user agent or downloaded content 210.

The service worker can be loaded immediately when the client 102 requests to load the content from the server for the first time, i.e. at the time the server 104 receives an initial client request from client 102. For example, in response to the first client request, the reverse proxy 204 and/or server 104 may forward the client request to a loader site, which can serve the service worker, as in the examples of FIGS. 1 and 6. Once loaded, the service worker can ensure the proxy 206 (for example, a script such as JavaScript) is operational on the side of client 102, and can initiate the proxy 206 in case it is not.

Subsequently, the reverse proxy 204 and forward proxy 206 may intercede between the two communication endpoints. For example, a first endpoint may include client 102 and/or user agent or downloaded content 210, while a second endpoint may include server 104 and/or the server-side content 202. Accordingly, in various non-limiting examples, the reverse proxy 204 and forward proxy 206 may intercede between client 102 and server 104, between a user agent (such as a web browser or other client application) and server 104, or between downloaded content 210 and server-side content 202. Together, the service worker, proxy 206, and cryptographic binary instructions 208 can ensure that all subsequent communications between the endpoints (e.g., client 102 and server 104) are encrypted using a post-quantum encryption protocol, via the double encryption scheme described in FIG. 4 below. In some examples, the disclosed system and methods can ensure that communications between the endpoints are quantum-aware, quantum-resistant, and/or quantum-secure, even without the user needing to be aware of their operation.

FIG. 3 is a block diagram illustrating a virtual machine (VM) 302 implementing a custom cryptography library 304 within a secure virtualized environment of a user agent 210 (such as a client application), according to an embodiment of the present disclosure. For example, VM 302 may include a bytecode interpreter such as the Java Virtual Machine, or the like. In some examples, VM 302 and/or the secure virtualized environment can comprise an independent context of execution within the user agent 210. In particular, this independent context of execution may have an independent memory space, thereby protecting the user agent 210 and/or the client device against the risks of malware or malicious attacks.

In this example, the VM 302 can implement a custom cryptography library 304, which may be called by the portable binary instructions and/or bytecode 208 via a POSIX socket 306. For example, portable binary instructions and/or bytecode 208 can include portable binary instructions that may be executed by the user agent 210 directly, and/or via a VM 302, such as a binary and/or bytecode interpreter, the Java Virtual Machine, or the like. Alternatively or additionally, the portable binary instructions can include compiled object code and/or machine code.

In yet other examples, the proxy service (such as proxy service 206 of the example of FIG. 2) can call interpreted instructions and/or scripts, such as JavaScript, to perform custom cryptography, and is not limited by the present disclosure. In some examples, an additional library or set of script instructions (e.g., JavaScript) can communicate with portable binary instructions and/or bytecode 208 and can handle proxy and translation and/or encapsulation, as in the example of FIG. 4 below. In some examples, such an additional library or script instructions (not shown) may be situated between portable binary instructions and/or bytecode 208 and network 106.

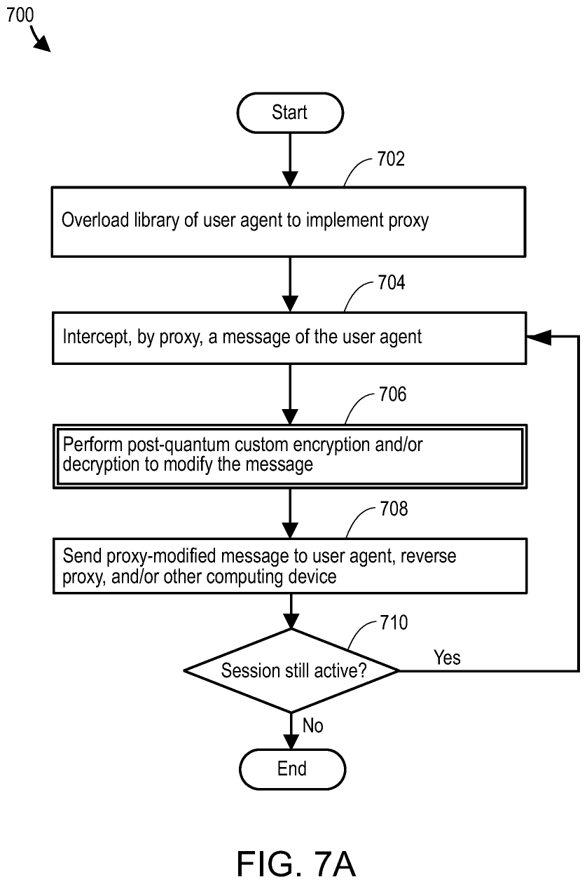

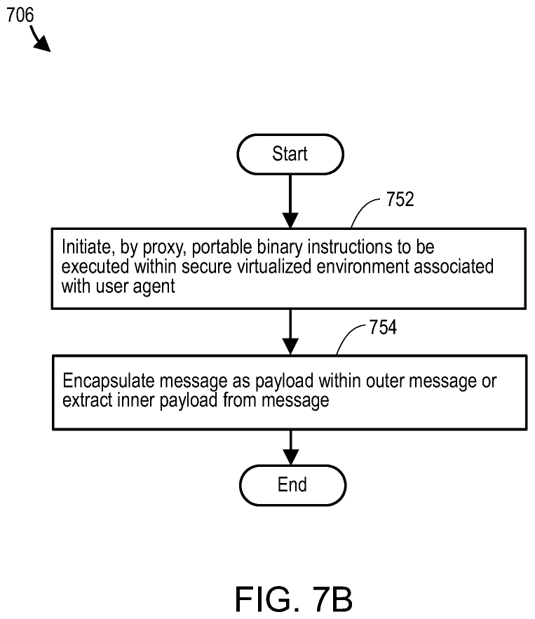

The portable binary instructions 208 may implement custom encryption and/or decryption on messages, such as requests from the user agent 210 and/or responses from the server 104, as described in greater detail in the examples of FIGS. 4-5 and 7A-7B below, and can then send the modified messages to the user agent 210, as described in the example of FIG. 7A. For example, portable binary instructions 208 and/or custom cryptography library 304 may receive a message to be encrypted or decrypted (for example, encrypted data 308 received via network 106 from server 104 and/or a reverse proxy, or data to be encrypted before being sent via the network 106), and may pass the message to the portable binary instructions 208. The portable binary instructions 208 and/or the custom cryptography library 304 may subsequently encrypt and/or decrypt the message, and return the result to the VM 302, and/or the user agent 210.

In some examples, the custom cryptography library 304 and/or portable binary instructions 208 can implement one or more quantum-aware, post-quantum, quantum-secure, or quantum-resistant encryption and/or decryption methods. For example, the system may perform the custom encryption and/or decryption according to a Quantum Secure Layer (QSL) protocol, a Post-Quantum Transport Layer Security (PQTLS) protocol, and/or another quantum-aware protocol. In various examples, the system may perform the custom encryption and/or decryption according to the National Institute of Standards and Technology (NIST) post-quantum encryption competition candidate algorithms, such as a Kyber algorithm, a SABER algorithm, an Enhanced McEliece algorithm, or a Random Linear Code Encryption Scheme (RLCE) algorithm. Accordingly, the disclosed system and methods improve over other cryptographic systems and provide industrial applicability by offering significantly improved resilience against attacks by non-classical computers such as quantum computers.

In some examples, the disclosed system and methods can make use of browser support for features such as portable binaries and/or bytecodes 208 in order to execute custom cryptography libraries 304 on demand from any user agent or client application 210, such as any browser. In particular, by utilizing portable binaries and/or bytecodes 208, the disclosed system improves over other cryptographic systems and provides industrial applicability, for example by loading one or more custom cryptology algorithms that need not be supported natively by the browsers. This portability and transparency enables the disclosed system and methods to apply post-quantum encryption in a modular, backward-compatible, and future-proof way, for example without the requirement of an end user installing or using a custom-compiled web browser with native support for the custom crypto libraries. In addition, in order to protect the end-user, the disclosed system and methods can utilize the memory-safe, secured, and sandboxed environment of VM 302 rather than sharing memory with the web application space.

FIG. 4 illustrates encapsulation and custom cryptography 400, according to an embodiment of the present disclosure.

In this example, first the client can create a message, such as a request 402. As shown, request 402 can include headers, which may describe the contents of the message (e.g., the headers may describe the message's content type, content length, the message's origin, or the like), and a body, which may contain private information such as webform details, a user login, or an email.

Next, the request 402 can be intercepted by the proxy service. The request 402 can be encrypted and encapsulated within a modified message 404. In this example, the disclosed proxy service can encrypt the entire original message 402, including both the body and headers, and package the encrypted, encapsulated message within the body of a new, modified message 404. The proxy service can furthermore create a new header for the modified message 404. For example, the proxy service can create new qsec headers for the quantum-secure modified message 404, such as an initiator unique ID (qsec_initiator_uid), a message count (qsec_message_count), a message byte count (qsec_byte_count), a quantum-secure hash (qsec_hash), and/or a quantum-secure protocol (qsec_proto). In some examples, the proxy service may pass through, or copy, a subset of the headers of original message 402 that remain relevant to modified message 404, such as the original cookie, origin, and/or referer headers. For example, the origin header may pass through, since the proxy service may be designed to add a layer of custom encryption to the message without changing routing information such as its origin. In an example, the pass-through headers may be copied, such that an encrypted copy of the pass-through headers remains in the encapsulated original message, while a second copy of the pass-through headers is included within the headers of the modified message 404. In some examples, copying or passing through headers may facilitate communication compatible with representational state transfer (REST), also referred to as RESTful communication.

In some examples, in order to provide an additional layer of obfuscation around the metadata of a request, the proxy service may modify all HTTP requests so as to target a single URL and/or path. In some examples, such a modification may not change the destination's hostname, but may change a directory on the host that receives the request. For example, the proxy service may set all requests to target “/qs/proxy”, which may direct the request to the reverse proxy on the server side, rather than directly to the destination of the original message. Moreover, the proxy service may remove or modify all headers pertaining to the user from the modified request in order to further protect the security of the original request. Specifically, the proxy service may encrypt all the data from the original headers, and replace the original headers with modified headers that do not reveal any user information. The proxy service may add such extra layers of security before encrypting the modified payload, which may encapsulate both the data and the metadata of the original request. In some examples, both the forward and reverse proxies can be configured to follow the same well-defined conventions and processes for intercepting messages, such as requests and/or responses, as illustrated in this example. Accordingly, the forward and reverse proxies can implement processes that are compatible with each other.

In some examples, the modified message 404 can be passed back to the user agent, such as a browser or other client application. The user agent can encrypt the modified message 404, as it normally would do with any message, resulting in an outer layer of legacy encryption surrounding the modified message 404. This illustrates the transparency of operation of the disclosed system. For example, using the disclosed system and methods, any user agent can encrypt the modified message 404 on demand without needing to be aware that custom cryptography has already been performed on the message. Accordingly, the original message can be double-encrypted.

In some examples, the user agent may encrypt the modified message 404 using Transport Layer Security (TLS), such as TLS version 1.2 or 1.3, or a subsequent TLS version. Alternatively, the disclosed system and methods may be used with any outer cryptographic protocol to encapsulate the quantum inner channel. In particular, a web browser or other client application or user agent may use any cryptographic protocol, including other legacy encryption protocols, to encrypt the modified message 404. In various examples, the quantum channel (such as QSL, PQTLS, or a NIST post-quantum candidate algorithm) may also be encapsulated in an Internet Message Access Protocol (IMAP) such as IMAP4, IMAP2bis, IMAP2, or another IMAP version; a Hypertext Transfer Protocol (HTTP) or Hypertext Transfer Protocol Secure (HTTPS); a hybrid protocol; a serial data bus protocol, such as the protocol of a CAM bus, a MIL-STD-1553 protocol, or the protocol of a satellite; an Open Mission Systems (OMS) architecture specification of the United States government; a Future Airborne Capability Environment (FACE) standard of the Open Group consortium; or another secure protocol.

Next, the double-encrypted message can be sent to a receiving quantum-secure reverse proxy, such as a server having the disclosed reverse proxy. In some examples, the double-encrypted message can be sent to another client having the disclosed proxy, and is not limited by the present disclosure. The receiving server and/or client may decrypt the outer layer of encryption (e.g., TSL, or another outer cryptographic layer, as described above) to obtain the modified message 404. The reverse proxy and/or forward proxy can then intercept, decrypt, and reassemble the modified message 404 to obtain a fully decrypted message 406, which may be identical to the original message 402, or otherwise reproduce its contents. The headers of decrypted message 406 may also be identical to the headers of the original message 402, or otherwise reproduce their contents. Finally, the reverse proxy and/or forward proxy can forward the fully decrypted message 406 to its destination, such as a server having the disclosed reverse proxy and/or another client having the disclosed proxy.

FIG. 5A is a communication flow diagram illustrating a method 500 of proxying via a service worker to implement double encryption and/or double decryption, according to an embodiment of the present disclosure. The method 500 may be performed by a system including a server 104 executing a web application 202, a reverse proxy 204, a loader service 112, and a client 102 executing a client application such as a browser. In an embodiment, the client 102 may execute a proxy and/or service worker 206, as well as a DOM, a web application or other downloaded content, or a client application 210, for example a browser.

In an example, the client application 210 (e.g., a browser) first receives a user request 502. For example, a user may type a URL, such as http://customer.com, in the browser window.

Next, the client application 210 can send a client request 504 to the server 104 based on the received user request 502. For example, the client application 210 may be a browser that performs an HTTPS GET action for a URL entered by a user, such as http://customer.com. The client request 504 may be received and/or intercepted by the reverse proxy 204, which may intercede between the server 104 and the network, for example the Internet.

The reverse proxy 204 may receive and forward 506 the request to a loader site 112. In some examples, the loader site 112 may be an offsite server and/or a third-party service. The loader site 112 may receive the forwarded request 506, and may respond to the reverse proxy 204 with initial content 508, such as HTML and/or JavaScript. For example, the initial content 508 may include the service worker (SW). Forwarding 506 and responding 508 to the request is described in greater detail in the examples of FIG. 1 above and FIG. 6 below.

Next, the reverse proxy 204 can respond 510 to the client request 504. For example, instead of the requested page, reverse proxy 204 may serve 510 the initial content 508 (for example, HTML and/or JavaScript) received from the loader site 112, to client 102. In some examples, the initial content 510 served by reverse proxy 204 may include a service worker.

Next, the client application 210 can install and/or initiate the received service worker, which may implement a forward proxy 206 that can intercede between the client 102 and the network (e.g., the Internet). In various examples, the SW may initiate the forward proxy 206, ensure the forward proxy 206 remains active, and/or can itself implement the functionality of forward proxy 206. For example, forward proxy 206 may intercept messages sent to and from client 102 via the network. In some examples, the SW can detect 511 its own initialization and/or installation, and in response can call for a custom crypto binary.

Next, the SW or forward proxy 206 may send a request 512 to download a custom crypto binary from the reverse proxy 204 and/or the server 104.

The reverse proxy 204 may receive the request 512, and may forward 514 the request to the loader site 112. The loader site 112 may receive the forwarded request 514, and may respond 516 to the reverse proxy 204 with a custom crypto binary. Forwarding 514 the request to the loader site 112 is described in greater detail in the examples of FIG. 1 above and FIG. 6 below.

The reverse proxy 204 can then send the custom crypto binary 518 to the SW 206. For example, the custom crypto binary 518 may include a portable binary such as portable binary instructions 208, of the examples of FIGS. 2 and 3.

Next, upon receiving the custom crypto binary 518, the SW 206 can initialize 520 the custom crypto binary 518, and can then perform a handshake 522 with the reverse proxy 204 for the custom encryption protocol.

For example, the proxy 206 can send a quantum secure layer (QSL) protocol session registration 522 corresponding to the handshake to the reverse proxy 204. In some examples, a session must be established with the reverse proxy 204 before the proxy service implemented by the custom crypto binary 518 can become operational. For example, it may be necessary for the SW 206 to perform a handshake and transfer keys with the reverse proxy 204 in order to establish the session.

The reverse proxy 204 may receive the QSL session registration request 522, and may forward 524 the request to a session registration service. In some examples, the session registration service may be an offsite server and/or a third-party service. In various examples, the session registration service may be the same as the loader site and/or may be separate from the loader site, and is not limited by the present disclosure.

The session registration service may receive the forwarded request 524, and may respond 526 to the reverse proxy 204.

Next, the reverse proxy 204 can send 528 the response to the proxy 206.

Next, the SW 206 can register 530 a fetch event listener to the proxy 206 and consume client-side policies, if the SW 206 is initialized. For example, the policies may include enabled algorithms, a message count, a message limit, a geographic location, a user identity, known vulnerabilities, artificial intelligence (AI)-flagged vulnerabilities, and/or any other policies.

Finally, the proxy 206 can reload 532 the client application 210, such as a browser.

FIG. 5B is a communication flow diagram illustrating a method 550 of proxying via a service worker to implement double encryption and/or double decryption, according to an embodiment of the present disclosure. In some examples, the method 550 can be a continuation of the method 500 of FIG. 5A above. For example, after the proxy 206 reloads the client application 210 in operation 532 of method 500, the client application 210 may continue to perform operation 552 of method 550. The method 550 may be performed by a system including a server 104 executing a web application 202, a reverse proxy 204, a loader service 112, and a client 102 executing a client application such as a browser. In an embodiment, the client 102 may execute a proxy and/or service worker 206, a DOM, a web application or other downloaded content, or a client application 210, for example a browser.

In an example, in response to being reloaded, the client application 210 may resend 552 the client request to the proxy 206. For example, the client application 210 may be a browser that repeats an earlier HTTPS GET action for a URL, such as http://customer.com. This new request 552 may be received and/or intercepted by proxy 206. In some examples, the fetch event listener can recognize the request 552 as a fetch event.

Next, provided that the SW or forward proxy 206 is installed and active, the SW or forward proxy 206 can invoke the policy-enabled custom crypto binary to encapsulate and proxy 554 the intercepted request. For example, the custom crypto binary and/or the proxy 206 can encapsulate and proxy 554 the request as described in FIG. 4 above.

Next, the forward proxy 206 can send the encapsulated and double-encrypted request 556 to the server 104. The encapsulated and double-encrypted request 556 may be received and/or intercepted by the reverse proxy 204.

Next, the reverse proxy 204 can decrypt, assemble, and proxy call 558 the received request according to any enabled policies. For example, the reverse proxy 204 can decrypt and reassemble 558 the request as described above in the example of FIG. 4.

Next, the reverse proxy 204 can forward the request 560 to the server 104.

Next, the server 104 can respond 562 to the request. The response 562 may be received and/or intercepted by the reverse proxy 204.

Next, the reverse proxy 204 can encapsulate and encrypt 564 the response.

Next, the reverse proxy 204 can send 566 the encapsulated and double-encrypted response to the client 102. The encapsulated and double-encrypted response 566 may be received and/or intercepted by proxy 206.

Next, the proxy 206 can decrypt and reassemble 568 the response. For example, the proxy 206 can decrypt and reassemble 568 the response as described above in the example of FIG. 4. The proxy 206 can create a response payload.

Finally, the proxy 206 can send the decrypted response 570 to the client application 210 (e.g., a browser).

FIG. 6 is a flow diagram illustrating a method 600 of proxying via a service worker, according to an embodiment of the present disclosure. In various examples, the method 600 may be implemented by a server, a loader site, and/or a client, such as server 104, loader site 112, and client 102 of the example of FIG. 1 above.

In this example, the method 600 can start with the server and/or a reverse proxy of the server receiving 602 a request from the client and/or a proxy service of the client. For example, a server for a website, such as a bank website, may receive an HTTPS GET request from a client to load the website.

Next, the server and/or the reverse proxy can determine 604 whether the request satisfies a security condition. For example, the service worker may determine 604 whether the request is quantum-aware (e.g., quantum-resistant and/or quantum-secure). As described in the examples of FIGS. 2-5 above and FIG. 7A below, if the disclosed proxy system is active, the double-encrypted request forwarded by the client's proxy service will be quantum-aware, and therefore the request received by the server will fulfill the security condition. By contrast, if the request is an initial request from a legacy, quantum-unaware client application that has not yet initiated the proxy service, or a policy is unfulfilled, then the request will fail to fulfill the security condition.

Alternatively, in some examples, the service worker may determine 604 whether the service worker and/or the proxy service has been initiated. In some examples, the security condition can include both whether the proxy service has been initiated and whether the request is quantum-aware, or can include any combination of these conditions.

Responsive to the request fulfilling the security condition and/or any applicable policies, the method can continue with operation 610 below. Responsive to the request not fulfilling the security condition or policies, the method can continue with operation 606.

Next, responsive to the request not fulfilling the security condition, the server and/or reverse proxy can forward 606 the request to the loader site. For example, the loader site may be an offsite server and/or a third-party service.

Next, the loader site can send a service worker to the reverse proxy, which can serve 608 the service worker to the client. The service worker sent by the loader site may include HTML and/or script instructions, such as JavaScript. The user agent may be configured to initiate received HTML and/or script instructions, and therefore may initiate the service worker when the user agent receives it. In an example, the user agent may execute the received JavaScript instructions because they are embedded within received HTML. The JavaScript instructions, in turn, may initiate the SW.

In some examples, the service worker can be configured to initiate the proxy service, and/or may implement the proxy service. Initiating the proxy service by the service worker will be described in greater detail in the example of FIG. 7A below. The proxy service initiated by the SW may be configured to intercept messages, such as requests and responses, and perform custom cryptography on the intercepted messages.

In some examples, the service worker can optionally check 610 whether a session of the service worker and reverse proxy remains active. For example, the SW and reverse proxy can have a session expiration time, and the server may indicate whether the session has expired. In another example, the server may indicate whether the session is invalid, for example, because the reverse proxy underwent a security change, the session keys have been wiped, or a session key has expired. In some examples, checking 610 whether the session remains active may include checking whether the proxy service remains operational.

In some examples, the system may implement lifecycle methods to check whether the proxy service remains operational, for example by implementing listeners for the service worker and/or for revival of the service worker. A user agent, such as a browser, may manage when a SW persists in memory, hibernates, or is killed due to disuse or due to the passage of an expiration time. The user agent may detect when the SW is revived, and may perform checks depending on how the SW was revived or brought into communication with the user agent. For example, the user agent may reinitialize the SW, or determine that the SW's session with the proxy is still active, and continue the session.

In some examples, when the proxy intercepts a message, it may preferably check 610 whether the session is active. Alternatively or additionally, the service worker may check 610 at regular intervals whether the session is active, such as every second, every 30 seconds, every 5 minutes, every 15 minutes, every hour, or every 10 hours. In another example, the service worker may check 610 whether the session is active in response to some other event, such as another client request or a server response.

Based on the indication from the server or reverse proxy, the service worker can determine 612 whether the session remains active. Responsive to the session remaining active, the method can continue with operation 616 below. Responsive to the session not remaining active, the method can continue with operation 614.

Next, responsive to the proxy determining that the session has expired or does not remain active, the service worker can reestablish 614 the session before proxying the call. For example, the proxy may request from the reverse proxy and/or the server to establish a new session. In another example, reactivating 614 the proxy service may follow a procedure similar to initiating the proxy service, as described in the example of FIG. 7A below. When the session has been reestablished 614, the method can then return to operation 610.

Alternatively, if the proxy is unable to establish a new session, this may suggest that the proxy's identity has been revoked or a policy is unfulfilled. In such a case, the method 600 may then end.

Responsive to the session remaining active, the service worker can determine 616 whether a user has terminated the session. Responsive to the user not having terminated the session, the method can return to operation 610. Responsive to the user having terminated the session, the method 600 can then end.

FIG. 7A is a flow diagram illustrating a method 700 of custom cryptography, according to an embodiment of the present disclosure. In various examples, the method 700 may be implemented by a virtual machine (VM), such as the VM 302 of the example of FIG. 3 above, which may execute portable binary instructions within a secure virtualized environment of a user agent, for example the client application 102 of the example of FIG. 1 above. Alternatively or additionally, the method 700 may be implemented by the user agent, for example the client application 102, and/or by a service worker, for example the service worker 116 of the example of FIG. 1 above, or a proxy service.

In this example, the method 700 can start with the service worker overloading 702 a library of the user agent to implement a proxy service. For instance, as described in the example of FIG. 6 above, the service worker can check whether the session is active and/or the proxy is operational, and responsive to the session not being active, the service worker can reestablish the session and/or reinitiate the proxy.

In some examples, the proxy service may be implemented via a script that can be interpreted and/or executed in the user agent, for example JavaScript executed by a web browser or other client application, and/or via HTML. Accordingly, implementing the proxy service can involve initiating the JavaScript or other script and/or HTML. For example, the web browser or other client application may expose functions, such as library functions, that can be called during request and response, for example by JavaScript or another script. In some embodiments, the SW can overload 702 such exposed functions to initiate and/or implement the proxy. Overloading 702 the library of the user agent to implement a proxy service is further described in the example of FIG. 3 above.

Next, the proxy service can intercept 704 a message of the user agent, such as a request from the user agent and/or a response from a server. Note that, in some examples, the method 700 can apply to messages being sent in either direction between the client and server.

As illustrated in the example of FIG. 2 above, the proxy and reverse proxy can intercede in communications between the client and server via a network such as the Internet. Accordingly, when the user agent sends a message to the network, the proxy service may intercept 704 it. For example, in a case where the proxy service is implemented via JavaScript in a web browser, the JavaScript may include instructions to intercept 704 all messages sent or received by the web browser, for example by overloading a function of the web browser or other client application. Intercepting 704 the message of the user agent is further described in the example of FIG. 4 above.

Next, the proxy service can perform 706 custom encryption and/or decryption to modify the message. In an example, the proxy service can execute portable binary instructions within a secure virtualized environment of a user agent (for example, within a web browser or other client application) to perform custom encryption and/or decryption of a user request and/or a request response.

In some examples, performing 706 the custom encryption and/or decryption can include performing quantum-aware, post-quantum, quantum-secure, or quantum-resistant encryption and/or decryption. For example, the system may perform 706 the custom encryption and/or decryption according to a Quantum Secure Layer (QSL) protocol, a Post-Quantum Transport Layer Security (PQTLS) protocol, or another quantum-aware protocol. In various examples, the system may perform 706 the custom encryption and/or decryption according to the National Institute of Standards and Technology (NIST) post-quantum encryption competition candidate algorithms, such as a Kyber algorithm, a SABER algorithm, an Enhanced McEliece algorithm, or a Random Linear Code Encryption Scheme (RLCE) algorithm.

The custom encryption and/or decryption may involve double encryption and/or decryption, for example by encapsulating a request as a payload within an outer message or extracting an inner payload from a message, as described in the examples of FIGS. 4 above and 7B below. In some examples, the user agent may independently perform its own encryption and/or decryption on the message, and may be unaware of the second layer of custom encryption and/or decryption. The proxy service and/or a VM, a portable binary, or a cryptographic library may then perform the custom encryption and/or decryption as a second encryption and/or decryption.

In particular, the user agent, such as a standard web browser, may be designed to apply standard legacy cryptographic protocols (such as TLS, RSA, or the like) to all communications. By comparison, the disclosed system is capable of adding a quantum-aware second layer of cryptography, thereby providing effective protection against quantum attacks.

In some examples, the user agent may perform legacy cryptography after the disclosed system performs custom cryptography, so in such cases the user agent may encrypt and/or decrypt the modified message. For example, in a case where the quantum-aware encryption forms an inner layer of encryption, the disclosed crypto binary can encrypt the message (e.g., from plaintext) first to obtain a modified message, and the user agent can subsequently encrypt the modified message before sending it. In the same example, when receiving a double-encrypted message, the user agent can decrypt the legacy outer encryption layer first, and the disclosed crypto binary can subsequently decrypt the quantum-aware inner encryption layer.

In some embodiments, the disclosed system and methods can transparently add the second layer of quantum-aware cryptography, without the user agent needing to be aware of this second layer. For example, as part of the double encryption process, the disclosed system may create new headers for the double-encrypted message, and may encrypt both the original headers and the original body of the message into a new message body with quantum-aware encryption, as described in the example of FIG. 4. Accordingly, the user agent can then handle the double-encrypted, encapsulated message (such as message 404 in the example of FIG. 4) as if it were a normal message, for example directing the double-encrypted message based on the new headers.

Performing 706 custom cryptography via a portable binary is described in greater detail in the examples of FIG. 3 above and FIG. 7B below.

Next, the proxy service can send 708 the proxy-modified message to the user agent, the reverse proxy, and/or another computing device. When the user agent receives the modified message, it may encrypt, decrypt, and/or forward the modified message to the server. For example, in a case where the quantum-aware encryption forms an inner layer of encryption, if the message contains a request sent by the user agent to the server, the proxy may pass 708 the modified request to the user agent, which may then encrypt the modified request (for example, using legacy encryption) and forward the double-encrypted request to the server and/or the reverse proxy. In the same example, if the message contains a response received from the server, the user agent may decrypt the response (for example, using legacy decryption) before the disclosed proxy intercepts the response and performs custom decryption on the modified message.

In another example, in a case where the quantum-aware encryption forms an outer layer of encryption, if the message contains a response received from the server, the disclosed proxy service can intercept the double-encrypted response, decrypt the quantum-aware outer layer of encryption, and forward the modified response to the user agent, which may then decrypt the legacy inner layer of encryption of the modified response. In the same example, if the message contains a request to be sent to the server, the user agent may encrypt the request with legacy encryption before the disclosed proxy service intercepts the request. The proxy service may then encrypt the request with quantum-aware encryption, and forward the modified double-encrypted request to the user agent, which may then send the request to the server.

In yet another example, if the user agent does not perform cryptography, the quantum-aware encryption may form the only layer of encryption, and is not limited by the present disclosure.

Passing 708 the modified request to the user agent is further described in the examples of FIGS. 1, 2, and 5 above.

Next, the proxy may determine 710 whether a session of the proxy and reverse proxy remains active. For example, the SW and reverse proxy can have a session expiration time, and the server may indicate whether the session has expired or is invalid, for example, because the reverse proxy underwent a security change, the session keys have been wiped, or a session key has expired. In some examples, determining 710 whether the session remains active may include determining whether the proxy service remains operational.

Responsive to the session remaining active, the method can return to operation 704. In some examples, the proxy may subsequently intercept 704 a message in the opposite direction to the previous message. For example, if the proxy initially intercepted 704 a request from the user agent to the server, it may subsequently intercept 704 a server response.

Responsive to the session remaining active, the method 700 may then end.

FIG. 7B is a flow diagram illustrating details of a method 706 of double encryption and/or double decryption, according to an embodiment of the present disclosure. In some examples, the method 706 may provide additional details of the operation 706 of method 700 in the example of FIG. 7 above. In various examples, the method 706 may be implemented by a virtual machine (VM), such as the VM 302 of the example of FIG. 3 above, which may execute portable binary instructions within a secure virtualized environment of a user agent, for example the client application 102 of the example of FIG. 1 above. Alternatively or additionally, the method 706 may be implemented by the user agent, for example the client application 102, and/or by a service worker, for example the service worker 116 of the example of FIG. 1 above. Note that, in some examples, the method 706 can apply to messages being sent in either direction between the client and server. In particular, both the forward and reverse proxies can intercept messages (e.g., requests and/or responses). In some examples, both the forward and reverse proxies can be configured to follow the same conventions, such as well-defined processes for encapsulation and custom cryptography as disclosed herein, and accordingly the forward and reverse proxies can implement processes that are compatible with each other.

In this example, the method 706 can start with the proxy service initiating 752 portable binary instructions to be executed within a secure virtualized environment associated with the user agent. In some examples, the secure virtualized environment can comprise an independent context of execution within the user agent (e.g., a client application such as a web browser). Thus, when the proxy service intercepts a message, the proxy service can call the portable binary instructions to perform custom cryptography on the message. In some examples, the independent context of execution may have an independent memory space, thereby protecting the user agent and/or client device against the risks of malware, or malicious attacks.

In some examples, the portable binary instructions executed to perform the custom cryptography may be a bytecode. For example, a bytecode can include portable binary instructions that may be executed by a web browser or other user agent directly, and/or via an interpreter such as the Java Virtual Machine, or the like. Alternatively or additionally, the portable binary instructions can include compiled object code and/or machine code. In yet other examples, the proxy service can call interpreted instructions and/or scripts, such as JavaScript, to perform custom cryptography, and are not limited by the present disclosure.

The use of portable binaries and/or bytecodes enables the disclosed system and methods to improve over other cryptographic systems and provides industrial applicability. In particular, by virtue of loading and utilizing portable binaries and/or bytecodes, the disclosed system can transparently and portably implement custom cryptology libraries on demand within any browser. For example, the system can execute custom cryptology algorithms that need not be supported natively by the browser. By virtue of this transparency and portability, the disclosed system and methods can implement post-quantum cryptography in a modular and backward-compatible way, for example without requiring end users to install or use custom-compiled web browsers having native support for the specific crypto libraries. In addition, the disclosed system and methods can execute the portable binaries and/or bytecodes within a memory-safe, sandboxed, and secure virtualized environment, rather than sharing memory with the web application space, thereby providing improved security for the user agent.

In some examples, the portable binary instructions executed to perform the custom cryptography may have a modular design, for example they may be encapsulated within one or more custom cryptography modules. Accordingly, in some examples, the system can expeditiously change the choice of custom cryptographic methods or protocols in accordance with any applicable policies, for example by exchanging modules. In particular, in some examples, the proxy service and/or the portable binary instructions may implement custom logic so as to enable hot swapping of encryption methods.

Initiating 752 portable binary instructions to be executed within a secure virtualized environment is described further in the example of FIG. 3 above.

Next, the proxy service can encapsulate 754 the message as a payload within an outer message, or extract an inner payload from the message.

In an example where the message contains a request to be encrypted, the proxy service can encapsulate the body and headers of the request, and can then encrypt this encapsulated payload with the initialized custom encryption library.

In some examples, in order to add a layer of obfuscation around the metadata of a request, the system may modify all HTTP requests made from the browser so as to target a single predetermined URL and/or path. In some examples, all headers pertaining to the user may be filtered out of each request before the request is sent via the network. For example, the proxy service may encrypt all the data of the original headers, and replace the original headers with modified headers that do not reveal any user information. The proxy service may put this extra layer of protection into place before the payload is encrypted, thereby encapsulating both the data and the metadata of the request, as illustrated in FIG. 4 above. For example, the proxy may encapsulate the original headers, including the original destination URL and/or path, within the body of the modified message, as described in the example of FIG. 4. The proxy may add a modified header targeting the predetermined URL and/or path to the modified message. As described in the example of FIG. 7A, the proxy service may then send the double-encrypted request to the user agent and/or the client device, which in turn can send the double-encrypted request via the Internet or another network to the reverse proxy on the server side.

In another example of decrypting a response from the server, the system can perform the reverse steps of decryption and re-assembly of the original response object. For example, the user agent, such as a web browser, may first decrypt an outer layer of legacy encryption of the double-encrypted response. The proxy service may then decrypt the quantum-aware encryption layer after the outer layer is decrypted, and may re-assemble the original plain-text response object, as in the example of FIG. 4.

Double encryption and/or double decryption via encapsulating 754 the message as a payload within an outer message or extracting an inner payload from the message is described further in the example of FIG. 4 above.

The method 706 may then end.

FIG. 8 is a block diagram of an example computer system 800 which can perform any one or more of the methods described herein, in accordance with one or more aspects of the present disclosure. In one example, the computer system 800 may include a computing device and correspond to one or more of the client 102, server 104, loader 112, or any suitable component of FIGS. 1-3 and 5. The computer system 800 may be connected (e.g., networked) to other computer systems in a local area network (LAN), an intranet, an extranet, or the Internet, including via the cloud or a peer-to-peer network. The computer system 800 may operate in the capacity of a server in a client-server network environment. The computer system 800 may be a personal computer (PC), a tablet computer, a wearable (e.g., wristband), a set-top box (STB), a personal Digital Assistant (PDA), a mobile phone, a smartphone, a camera, a video camera, an Internet of Things (IoT) device, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 800 (one example of a “computing device”) illustrated in FIG. 8 includes a processing device 802, a main memory 804 (e.g., read-only memory (ROM), flash memory, solid state drives (SSDs), dynamic random-access memory (DRAM) such as synchronous DRAM (SDRAM)), a static memory 806 (e.g., flash memory, solid state drives (SSDs), or static random-access memory (SRAM)), and a memory device 808, wherein any of the foregoing may communicate with each other via a bus 810. In some implementations, the computer system 800 may further include a hardware security module 824.

The processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a system on a chip, a field programmable gate array (FPGA), a digital signal processor (DSP), network processor, or the like. The processing device 802 may be configured to execute instructions for performing any of the operations and steps discussed herein.

The computer system 800 illustrated in FIG. 8 further includes a network interface device 812. The computer system 800 also may include a video display 814 (e.g., a liquid crystal display (LCD), a light-emitting diode (LED), an organic light-emitting diode (OLED), a quantum LED, a cathode ray tube (CRT), a shadow mask CRT, an aperture grille CRT, or a monochrome CRT), one or more input devices 816 (e.g., a keyboard and/or a mouse or a gaming-like control), and one or more speakers 818 (e.g., a speaker). In one illustrative example, the video display 814 and the one or more input devices 816 may be combined into a single component or device (e.g., an LCD touchscreen).

The memory device 808 may include a computer-readable storage medium 802 on which the instructions 822c embodying any one or more of the methods, operations, or functions described herein are stored. The instructions 822c may also reside, completely or at least partially, within the main memory 804 as instructions 822b and/or within the processing device 802 during execution thereof by the computer system 800. As such, the main memory 804 or as instruction 822a and the processing device 802 also constitute computer-readable media. The instructions 822 may further be transmitted or received over a network via the network interface device 812.

While the computer-readable storage medium 820 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium capable of storing, encoding or carrying out a set of instructions for execution by the machine and that cause the machine to perform any one or more of the methods disclosed herein. The term “computer-readable storage medium” shall accordingly be taken to include, but not be limited to, solid-state memories, optical media, and magnetic media.

While the computer system environment of 800 shows the basic components the addition of a Hardware Security Module 824 associated with a Quantum Random Number Generator 826 are added to complete the entropy required for Post Quantum computations and interactions. The use of these components is critical as described previously in the overall methods used for this system.

No part of the description in this application should be read as implying that any particular element, step, or function is an essential element that must be included in the claim scope. The scope of patented subject matter is defined only by the claims. Moreover, none of the claims is intended to invoke 25 U.S.C. § 104(f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Once the above disclosure is fully appreciated, numerous variations and modifications will become apparent to those skilled in the art. It is intended that the following claims be interpreted to embrace all such variations and modifications.

What is claimed:

1. A method of custom cryptography, comprising:
receiving, by a loader site from a second computing device, a forwarded request of a third computing device, wherein the forwarded request does not satisfy a security condition; and
sending, by the loader site to the third computing device, a persistent service worker configured to initiate a proxy service, the proxy service configured to perform post-quantum custom cryptography.

2. The method of claim 1, wherein the post-quantum custom cryptography comprises at least one of:
a Quantum Secure Layer (QSL) protocol;
a Post-Quantum Transport Layer Security (PQTLS) protocol;
a Kyber algorithm;
a SABER algorithm;
an Enhanced McEliece algorithm;
a Random Linear Code Encryption Scheme (RLCE) algorithm; or
a National Institute of Standards and Technology (NIST) candidate post-quantum algorithm.

3. The method of claim 1, wherein the persistent service worker is configured to persist from a first browser session to a subsequent browser session of the third computing device.

4. The method of claim 1, wherein the persistent service worker comprises at least one of a web worker or script instructions.

5. The method of claim 1, wherein a request received by the second computing device is determined, by a policy manager, not to satisfy the security condition, and wherein the forwarded request is forwarded, by the second computing device, based on the determination of the policy manager.

6. The method of claim 1, wherein the security condition indicates whether the forwarded request conforms to a post-quantum security standard or protocol.

7. The method of claim 1, wherein the security condition indicates at least one of:
whether the persistent service worker has been initiated; or
whether the proxy service has been initiated.

8. The method of claim 1, wherein the proxy service is configured to:
intercept a message of a user agent;
initiate portable binary instructions within a virtualized environment of the user agent, wherein the portable binary instructions comprise instructions to modify the message via custom cryptography;
obtain the modified message; and
send the modified message to a reverse proxy of the second computing device.

9. The method of claim 8, wherein:
to initiate the portable binary instructions comprises to load and/or to initialize a cryptographic library module; and
the cryptographic library module includes the portable binary instructions.

10. The method of claim 1, wherein the persistent service worker is further configured to:
determine whether a session associated with the persistent service worker remains active; and
responsive to the session being inactive, reestablish the session.

11. A loader computing system configured for custom cryptography, the loader computing system comprising:
a memory; and
at least one processor coupled to the memory and configured to:
receive, from a second computing device, a forwarded request of a third computing device, wherein the forwarded request does not satisfy a security condition; and
send, to the third computing device, a persistent service worker configured to initiate a proxy service, the proxy service configured to perform post-quantum custom cryptography.

12. The loader computing system of claim 11, wherein the post-quantum custom cryptography comprises at least one of:
a Quantum Secure Layer (QSL) protocol;
a Post-Quantum Transport Layer Security (PQTLS) protocol;
a Kyber algorithm;
a SABER algorithm;
an Enhanced McEliece algorithm;
a Random Linear Code Encryption Scheme (RLCE) algorithm; or
a National Institute of Standards and Technology (NIST) candidate post-quantum algorithm.

13. The loader computing system of claim 11, wherein the persistent service worker is configured to persist from a first browser session to a subsequent browser session of the third computing device.

14. The loader computing system of claim 11, wherein the persistent service worker comprises at least one of a web worker or script instructions.

15. The loader computing system of claim 11, wherein a request received by the second computing device is determined, by a policy manager, not to satisfy the security condition, and wherein the forwarded request is forwarded, by the second computing device, based on the determination of the policy manager.

16. The loader computing system of claim 11, wherein the security condition indicates whether the forwarded request conforms to a post-quantum security standard or protocol.

17. The loader computing system of claim 11, wherein the security condition indicates at least one of:
the persistent service worker having been initiated; or
the proxy service having been initiated.

18. The loader computing system of claim 11, wherein the proxy service is configured to:
intercept a message of a user agent;
initiate portable binary instructions within a virtualized environment of the user agent, wherein the portable binary instructions comprise instructions to modify the message via custom cryptography;
send the modified message to a reverse proxy of the second computing device; and
send the modified message to the user agent.

19. The loader computing system of claim 18, wherein:
to initiate the portable binary instructions comprises to load and/or to initialize a cryptographic library module; and
the cryptographic library module includes the portable binary instructions.

20. The loader computing system of claim 11, wherein the persistent service worker is further configured to:
determine whether a session associated with the persistent service worker remains active; and
responsive to the session being inactive, reestablish the session.

21. A non-transitory computer readable medium storing executable sequences of instructions for custom cryptography, the executable sequences of instructions comprising instructions to:
receive, from a second computing device, a forwarded request of a third computing device, wherein the forwarded request does not satisfy a security condition; and
send, to the third computing device, a persistent service worker configured to initiate a proxy service, wherein the proxy service is configured to perform post-quantum custom cryptography.

22. The non-transitory computer readable medium of claim 21, wherein the post-quantum custom cryptography comprises at least one of:
a Quantum Secure Layer (QSL) protocol;
a Post-Quantum Transport Layer Security (PQTLS) protocol;
a Kyber algorithm;
a SABER algorithm;
an Enhanced McEliece algorithm;
a Random Linear Code Encryption Scheme (RLCE) algorithm; or
a National Institute of Standards and Technology (NIST) candidate post-quantum algorithm.

23. The non-transitory computer readable medium of claim 21, wherein the forwarded request is forwarded, by the second computing device, responsive to a determination of a policy manager that the forwarded request does not satisfy the security condition.

24. The non-transitory computer readable medium of claim 21, wherein the security condition indicates whether the forwarded request conforms to a post-quantum security standard or protocol.

25. The non-transitory computer readable medium of claim 21, indicates at least one of:
the persistent service worker having been initiated; or
the proxy service having been initiated.

26. The non-transitory computer readable medium of claim 21, wherein the persistent service worker is further configured to:
determine whether a session associated with the persistent service worker remains active; and
responsive to the session being inactive, reestablish the session.
